(19) United States
(12) Patent Application Publication
(10) Pub. No.: US 2007/0028593 A1
(43) Pub. Date: Feb. 8, 2007

(54) Low-noise pulse jet engine

(75) Inventor: Yueping Guo, Seal Beach, CA (US)

Correspondence Address: LEE & HAYES, PLLC, 421 W. RIVERSIDE AVE., SUITE 500, SPOKANE, WA, 99201, US

(73) Assignee: The Boeing Company

(21) Appl. No.: 11/197,692

(22) Filed: Aug. 4, 2005

(51) Int. Cl. F02K 7/02

(52) U.S. Cl. 60/204; 60/247

(57) ABSTRACT

An engine including multiple pulse ducts. Each pulse duct has a hollow interior extending from an upstream end to a downstream end for transporting high-pressure fluid. The high-pressure fluid is expelled from the downstream ends of the pulse tubes during operation of the engine. The engine further includes an ejector adjacent the downstream ends of the plurality of pulse ducts comprising a plurality of segregated compartments. Each compartment is aligned with the downstream end of a corresponding pulse duct of the plurality of pulse ducts to receive the high-pressure fluid expelled from the downstream end of the corresponding pulse duct for preventing high-pressure fluid expelled from each pulse duct from interacting with fluid expelled from each adjacent pulse duct.

### BACKGROUND OF THE INVENTION

The present invention relates to an engine, and more particularly to a low-noise pulse jet engine.

Pulse jet engines produce thrust by creating and expelling high-pressure fluid. Most pulse jet engines include multiple pulse tubes mounted adjacent each other on the engine. The high-pressure fluid is expelled from the pulse tubes.

Conventional pulse jet engines generally produce high levels of audible noise. The high levels of noise generally result from constructive interference of the pressure waves of the high-pressure fluid emanating from adjacent pulse tubes. FIG. 1 shows a sum wave Σ1 resulting from interference of a first wave W1 and a second wave W2 emanating from adjacent pulse tubes (not shown). Because the first wave W1 and the second wave W2 are in phase with each other and have the same wavelength, the sum wave Σ1 has an amplitude that is larger than both of the individual waves and, specifically, equal to the sum of the amplitudes of the first and second waves. This phenomenon is referred to as constructive interference. Noise resulting from the combined waves W1, W2 is louder than the noise that would have resulted from the uncombined waves due to the higher summary amplitude Σ1. Further, because most pulse jet engines include more than two adjacent pulse tubes expelling in-phase pressure waves, the amount of constructive interference is increased and the resulting noise is louder.

### BRIEF SUMMARY OF THE INVENTION

The present invention relates to an engine including a plurality of pulse ducts. Each pulse duct has a hollow interior extending from an upstream end to a downstream end for transporting high-pressure fluid. The high-pressure fluid is expelled from the downstream ends of the pulse tubes during operation of the engine. The engine further includes an ejector adjacent the downstream ends of the plurality of pulse ducts comprising a plurality of segregated compartments. Each compartment is aligned with the downstream end of a corresponding pulse duct of the plurality of pulse ducts to receive the high-pressure fluid expelled from the downstream end of the corresponding pulse duct for preventing high-pressure fluid expelled from each pulse duct from interacting with fluid expelled from each adjacent pulse duct.

In another aspect, the invention includes a vehicle comprising a frame and an engine mounted on the frame. The engine includes a plurality of pulse ducts. Each pulse duct has a hollow interior extending from an upstream end to a downstream end for transporting high-pressure fluid. The high-pressure fluid is expelled from the downstream ends of the pulse tubes during operation of the engine. The engine further includes an ejector adjacent the downstream ends of the plurality of pulse ducts comprising a plurality of segregated compartments. Each compartment is aligned with the downstream end of a corresponding pulse duct of the plurality of pulse ducts to receive the high-pressure fluid expelled from the downstream end of the corresponding pulse duct for preventing high-pressure fluid expelled from each pulse duct from interacting with fluid expelled from each adjacent pulse duct.

In yet another aspect, the invention includes a method for propelling a vehicle using an engine having a plurality of pulse ducts through which high-pressure fluid having a wavelength and a frequency is propagated and an ejector mounted on the engine downstream from the plurality of pulse ducts through which the high-pressure fluid propagates upon exiting the pulse ducts. The method comprises selectively delivering high-pressure fluid through the plurality of pulse ducts and the ejector so the high-pressure fluid moving through at least one of the pulse ducts of the plurality of pulse ducts is out of phase with the high-pressure fluid moving through at least one other pulse duct of the plurality of pulse ducts. The method further comprises preventing high-pressure fluid exiting each pulse duct of the plurality of pulse ducts from interacting with high-pressure fluid exiting adjacent pulse ducts in the ejector.

Other features of the present invention will be in part apparent and in part pointed out hereinafter.

### BRIEF DESCRIPTION OF THE DRAWINGS

FIG. 1 is a graph showing constructive interference of two in-phase waves.

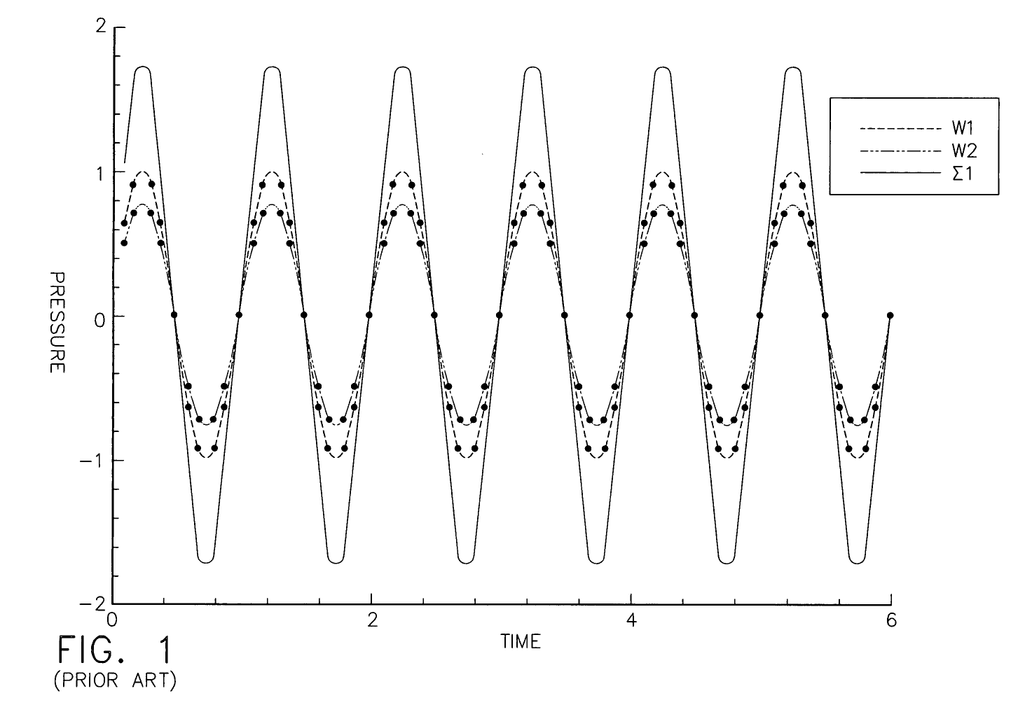

FIG. 2 is a perspective of a portion of an engine according to a first embodiment of the present invention.

FIG. 3 is a perspective of a portion of an engine according to a second embodiment of the present invention.

FIG. 4 is a front view of an engine according to a third embodiment of the present invention shown in combination with a vehicle.

FIG. 5 is a perspective of a portion of an engine according to a fourth embodiment of the present invention.

FIG. 6 is a graph showing canceling interference of two out-of-phase waves according to the present invention.

FIG. 7 is a perspective of an exit plane of an engine according to the present invention.

FIG. 8 is a graph showing noise reduction levels as a function of non-dimensional frequency.

Corresponding reference characters indicate corresponding parts throughout the several views of the drawings.

### DETAILED DESCRIPTION OF THE PREFERRED EMBODIMENT

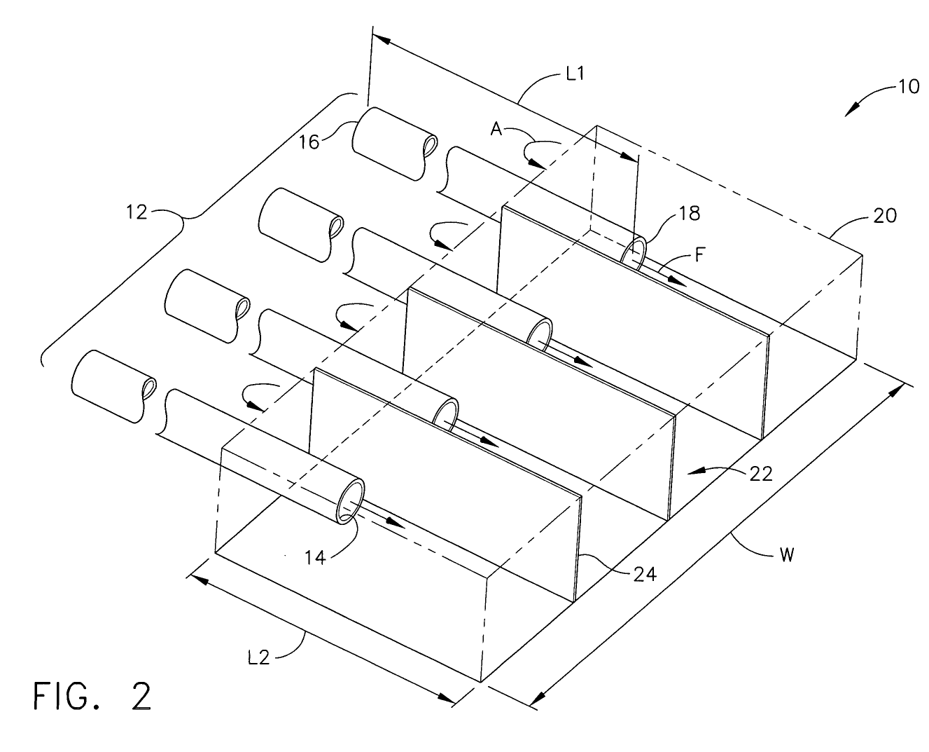

Referring now to the drawings and in particular to FIG. 2, an engine according to the present invention is designated by the reference numeral 10. The engine 10 includes multiple pulse tubes or pulse ducts 12. Each pulse duct 12 has a hollow interior 14 extending from an upstream end 16 to a downstream end 18 for transporting high-pressure fluid F. Although the pulse tubes may have other lengths L1 without departing from the scope of the present invention, in one embodiment each pulse duct has a length of between about 24 inches and about 36 inches. Although the pulse tubes may have other interior cross-sectional flow areas without departing from the scope of the present invention, in one embodiment each pulse duct has an interior cross-sectional flow areas of between about 5 square inches and about 7 square inches. The high-pressure fluid is expelled from the downstream ends 18 of the pulse ducts 12 during operation of the engine 10. Further, although the pulse tubes may have other cross-sectional shapes without departing from the scope of the present invention, in one embodiment the pulse tubes have a generally circular cross section.

The engine 10 further includes an ejector 20 adjacent the downstream ends 18 of the pulse ducts 12. Although the ejector 20 may have other cross-sectional shapes without departing from the scope of the present invention, in one embodiment the ejector has a generally rectangular cross section. Although the ejector 20 may have other lengths L2 without departing from the scope of the present invention, in one embodiment the ejector has a length of between about 3 feet and about 6 feet. Although the ejector 20 may have other widths W without departing from the scope of the present invention, in one embodiment the ejector has a width of between about 6 feet and about 8 feet. The ejector 20 comprises multiple chambers or compartments 22 separated by dividers 24. The number of compartments 22 into which the ejector 20 is divided depends on variables including space, power, and cost requirements. Although an ejector 20 having four compartments 22 is shown, the ejector may have other numbers of compartments without departing from the scope of the present invention. Although the compartments 22 may have other cross-sectional shapes without departing from the scope of the present invention, in one embodiment each compartment has a generally rectangular or square cross section. Each of the segregated compartments 22 is aligned with the downstream end 18 of a corresponding pulse duct 12 to receive the high-pressure fluid F expelled from the corresponding pulse duct. The dividers 24 ensure high-pressure fluid F expelled from each pulse duct 12 does not interact with fluid expelled from each adjacent pulse duct. Each compartment 22 is aligned with the engine to receive ambient air A into the compartment during operation of the engine 10. Because engine thrust levels relate to mass flow through the engine, increasing the mass flow by introducing ambient air A increases the thrust produced by the engine during operation.

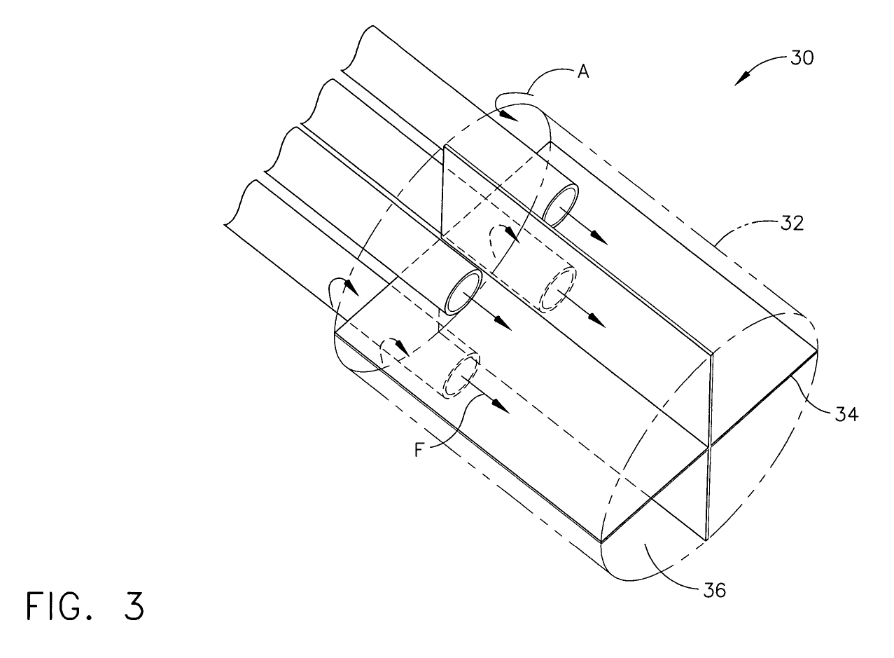

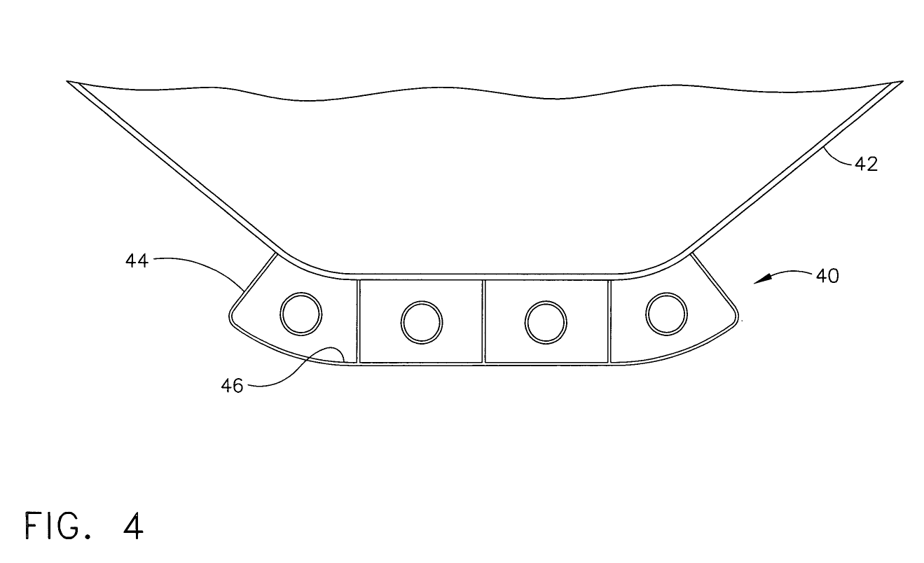

FIG. 3 shows an embodiment of an engine 30 according to the present invention including an ejector 32 having a generally circular cross section. Dividers 34 separate the ejector 32 of this embodiment into generally wedge-shaped compartments 36. In one embodiment (not shown), the ejector has an array of compartments comprising two or more stacked rows of compartments. FIG. 4 shows an embodiment of an engine 40 according to the present invention in combination with a vehicle 42. The engine 40 includes an ejector 44 having a shape corresponding to a shape of the vehicle 42 on which the ejector is mounted. At least one of the ejector 44 compartments 46 has a cross-sectional shape that is different from a cross-sectional shape of at least one other compartment. As will be appreciated by those skilled in the art, the shape of the ejector 44 and compartments 46 depends on many variables, including the shape of the vehicle 42 on which the ejector is mounted, the amount of thrust required, and the cost of making, using, and maintaining the engine 40. The compartments may also have different sizes. For example, in one embodiment, an area of a cross section of at least one compartment of the plurality of compartments is different than an area of a cross section of at least one other compartment of the plurality of compartments.

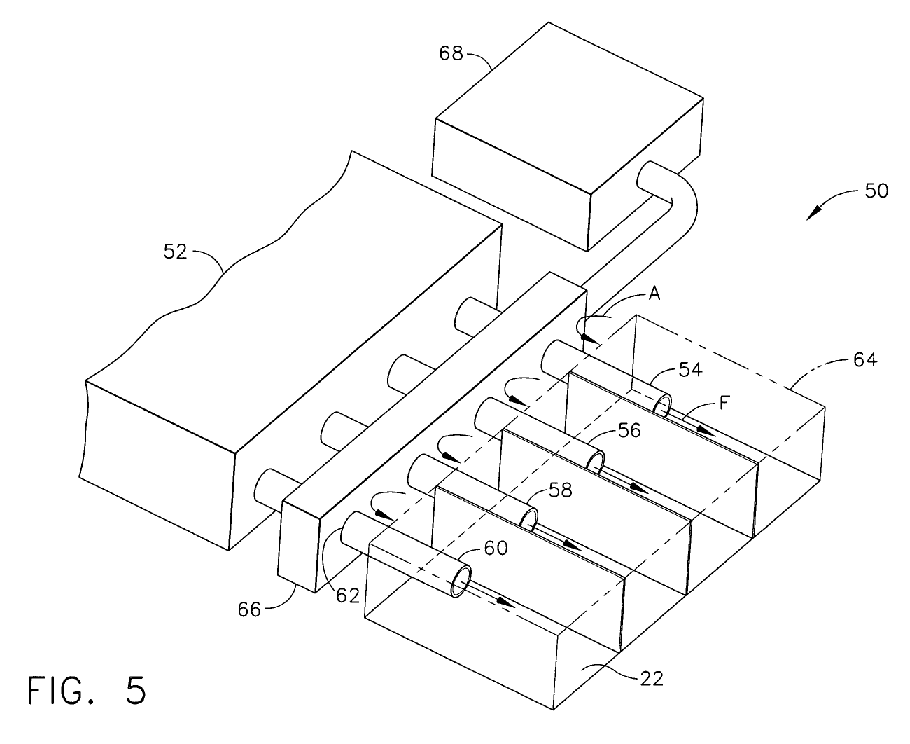

FIG. 5 shows an embodiment of an engine 50 according to the present invention including a combustor 52 operatively connected to a plurality of pulse ducts 54, 56, 58, 60 adjacent the upstream ends 62 of the pulse ducts. The combustor 52 receives and mixes air and fuel and heats the mixture to create the high-pressure fluid F that is received by and passed through the pulse ducts 54, 56, 58, 60 and ejector 64. The fluid may be pressurized in other ways without departing from the scope of the present invention. For example, in one embodiment (not shown) the fluid F is pressurized in the pulse ducts. For example, an engine can be configured so each pulse duct receives and mixes air and fuel and the mixture is heated in the pulse duct to pressurize the fluid F.

As shown in FIG. 5, a regulator 66 is operatively connected to the pulse ducts 54, 56, 58, 60 to control an amount of high-pressure fluid F received by each pulse duct. As will be appreciated by those skilled in the art, many types of regulators 66 can be used to control the amount of fluid F entering the pulse ducts. For example, in one embodiment, the regulator 66 includes a plurality of valves (not shown) wherein each valve is connected to a corresponding pulse duct 54, 56, 58, 60. In another embodiment, the regulator includes a movable plate (not shown) having holes so fluid is selectively allowed and prevent from entering each duct depending on the positioning of the plate.

A processor 68 is operatively connected to the regulator 66 to control the regulator. The high pressure fluid F propagates in the form of pressure waves having a frequency and a wavelength. The processor 68 controls the regulator 66 so the pressure waves moving through at least one of the pulse ducts 54, 56, 58, 60 is out of phase with the pressure waves moving through at least one other pulse duct. In one embodiment, the regulator 66 is controlled so the pressure waves propagating though at least one of the pulse ducts 54, 56, 58, 60 is delayed so it is out of phase with the pressure waves propagating through at least one adjacent pulse duct. In another embodiment, the regulator 66 is controlled so the pressure waves propagating through each pulse duct 54, 56, 58, 60 is out of phase with the pressure waves propagating through each adjacent pulse duct. For example, the processor 68 can operate the regulator 66 so the pressure waves propagating through the second pulse duct 56 is out of phase with the pressure waves propagating through the first and third pulse ducts 54, 58. For embodiments where the high-pressure fluid F is created in the pulse ducts, the phase delay between pressure waves propagating through adjacent pulse ducts may be created by controlling the timing of the heating of the air/fuel mixtures in the respective ducts. As will be appreciated by those skilled in the art, there are infinite combinations of phase differences that can exist between the various pulse ducts 54, 56, 58, 60. The particular combination of phases the processor 68 effectuates depends on variables including an amount of noise sought to be abated and a cost of making an engine capable of instituting the desired phase characteristics.

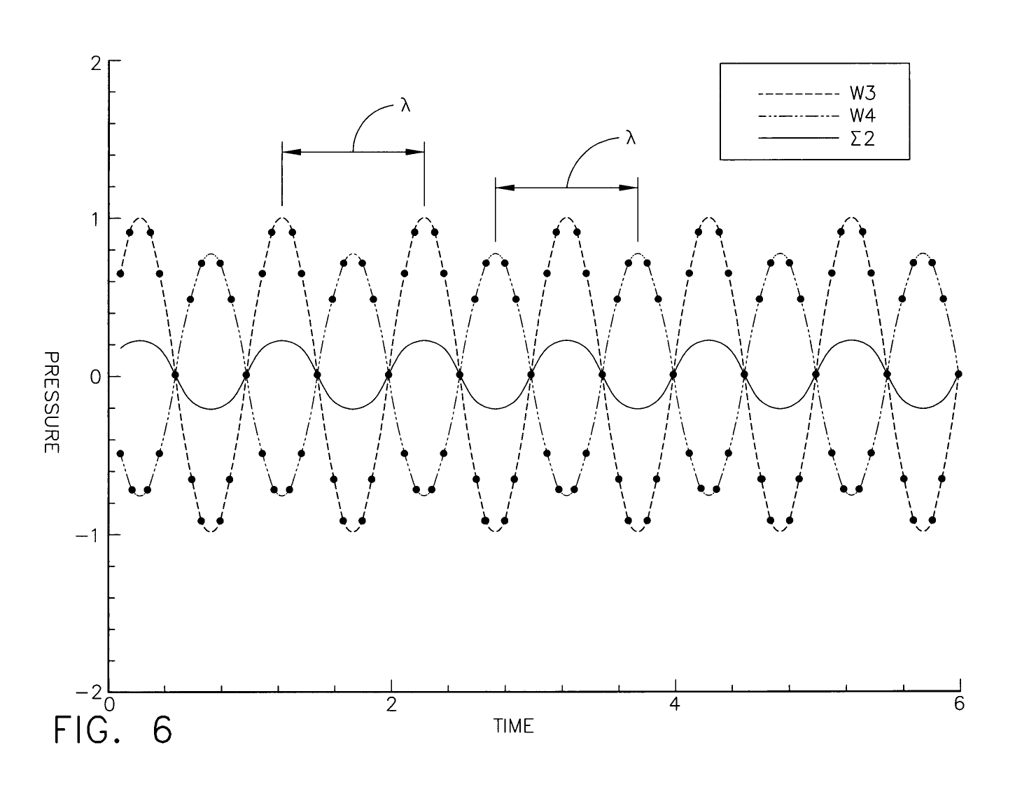

FIG. 6 shows the effect of superimposing waves W3, W4 expelled from adjacent pulse ducts. The waves W3, W4 have substantially the same wavelengths A and frequencies. Engines 10, 30, 40, 50 according to the present invention may be configured to abate noise associated with waves having different wavelengths and/or frequencies from each other. An amplitude of the first wave W3 is about 0.97 units and an amplitude of the second wave W4 is about 0.77 units. When the waves W3, W4 are out of phase by one-half of their wavelength λ, a sum wave Σ2 resulting from combination of the two waves W3, W4 has a frequency and wavelength equal to the frequency and wavelength of the waves and an amplitude of about 0.20 units, or the difference between the amplitudes of the respective waves. A maximum amount of destructive interference or phase cancellation between two waves W3, W4 having the same wavelengths will occur when the phase difference between the waves causes peaks of one of the waves W3, W4 to coincide with troughs of the other wave W3, W4. Various phase differences can be created between the pressure waves propagating out of the various pulse ducts to create various levels of noise abatement.

An amount of thrust produced by engines 10, 30, 40, 50 according to the present invention is not reduced as a result of the pressure wave delays that moderate aeroacoustic noise. Thrust is primarily produced in the ejector 20, 32, 44, 64, where the pressure waves propagating through adjacent compartments 22, 36, 46 are separated by dividers. Thus, the pressure waves of adjacent compartments 22, 36, 46 cannot cancel each other in the ejector 20, 32, 44, 64, where the thrust is produced. The amount of thrust produced by the expelled fluid F downstream from the ejector 20, 32, 44, 64 is much less than the amount of thrust produced in the ejector, yet the amount of noise produced by an engine primarily occurs downstream from the ejector. Thus, destructive interaction of pressure waves after being expelled from their respective ejector compartments 22, 36, 46 does not lower the thrust but does moderate aeroacoustic noise. Thrust levels are also maintained in engines 10, 30, 40, 50 according to the present invention because the amount of thrust produced in the ejector 20, 32, 44, 64 is represented by the time averaged momentum flux (i.e., velocity squared multiplied by density). The total thrust generated by engines 10, 30, 40, 50 having a divided ejector 20, 32, 44, 64 and delayed pulsation is no lower than the thrust that would be generated by engines having undivided ejectors and the same cross-sectional shape because the time averaged momentum flux is independent of phase variations and because the cross-sectional areas of conventional ejectors and ejectors according to the present invention including dividers are substantially the same because the dividers take up a nominal amount of the cross-sectional area of the ejector.

The noise reduction benefits of the present invention can be characterized using acoustic theory. As an example, a noise radiation efficiency η of a pulse jet engine including an ejector having a rectangular cross section and a linear array of pulse tubes can be characterized by the following equation:

$$η = 20 ⨯ log \vert \frac{1}{N} {\sum }_{n = 1}^{N} exp \{ ⅈ ω ( {τ}_{n} - {y}_{n} sin θ cos ϕ / c ) \} \vert \qquad equation ( 1 )$$

where:

η=noise radiation efficiency;

N=number of compartments in the ejector;

ω=angular frequency;

τₙ=time delay of the n^{th} pulse duct in the array;

yₙ=distance to the center coordinate of the exit plane of the ejector from the center of the n^{th} compartment;

θ=polar angle (between exit flow vector and microphone direction); and

φ=azimuth angle (between exit flow vector and the horizon).

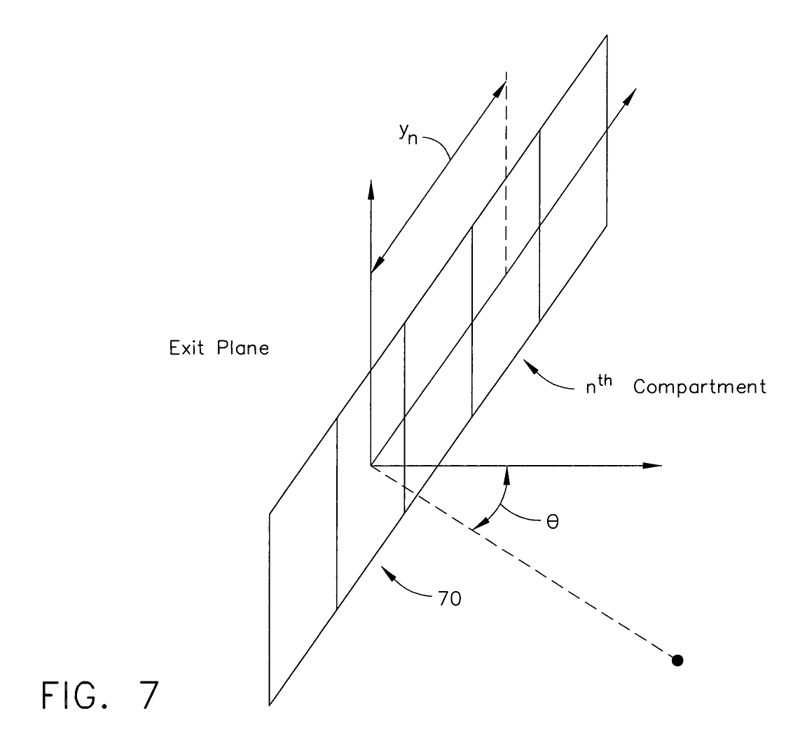

The geometry and coordinate system corresponding to the equation (1) is shown in FIG. 7. The center coordinate of the exit plane can be any point in the exit plane, as long as the same point is used as the reference for the distance measurement yₙ for each compartment. In FIG. 7, the center coordinate is located on the exit plane and in the center of the second compartment 70. The distance to the center coordinate yₙ is the distance from the center coordinate to the center of the n^{th} compartment on the exit plane. In conventional engines (not shown), where the ejector has no compartments (i.e., N=0), the time delay τₙ is 0, the distance to the center coordinate yₙ is 0, and thus the noise radiation efficiency η is 0. In engines having ejector compartments (i.e., N>1), the noise radiation efficiency η is greater than 0.

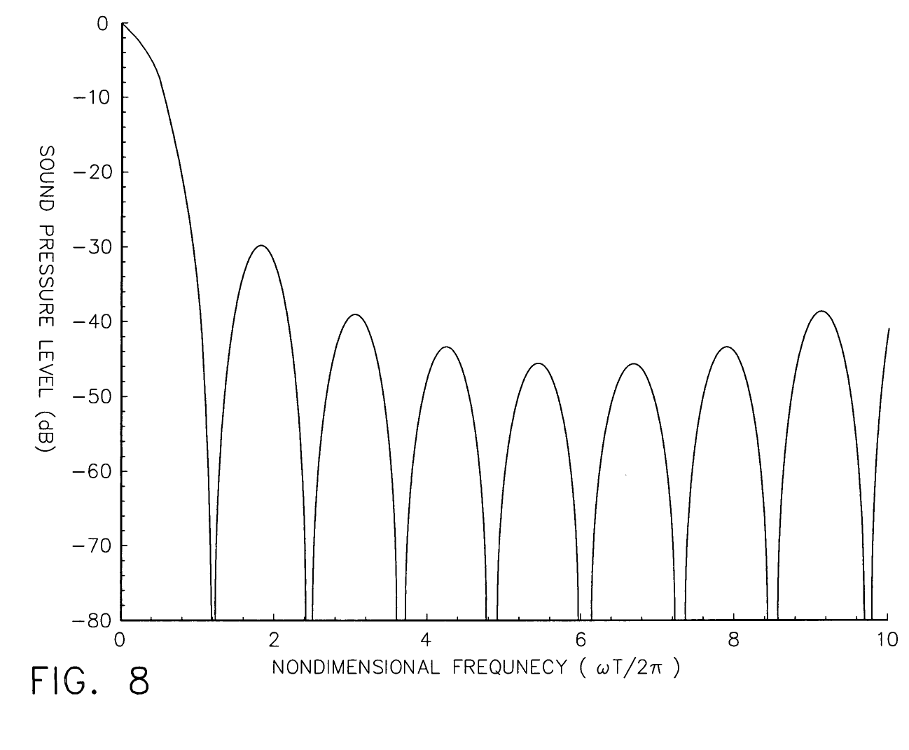

FIG. 8 illustrates the amount of noise reduction that can be accomplished using the present invention compared to conventional engines. FIG. 8 shows the change in sound pressure levels, measured in decibels, with respect to the change in non-dimensional frequency (i.e., ωT/2π, wherein T is the pulsation period of the pressure waves) according to the equation (1) when the polar angle θ is π/6 and the azimuth angle φ is π/4. Reducing pressure levels reduces noise. As can be seen from FIG. 8, there are many non-dimensional frequencies at which optimum noise reduction occurs. For example, for the engine and vehicle configuration used to generate the data in FIG. 8, optimum noise reduction levels occur at non-dimensional frequencies of about 1.3, 2.4, etc.

Engines according to the present invention can be used in combination with numerous types of vehicles. For example, engines according to the present invention can be mounted on and used in combination with aircraft, missiles, watercraft, and land vehicles.

When introducing elements of the present invention or the preferred embodiment(s) thereof, the articles “a”, “an”, “the”, and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. An engine comprising:
a plurality of pulse ducts, each pulse duct having a hollow interior extending from an upstream end to a downstream end for transporting high-pressure fluid, wherein the high-pressure fluid is expelled from said downstream ends of the pulse ducts during operation of the engine; and
an ejector adjacent the downstream ends of the plurality of pulse ducts comprising a plurality of segregated compartments, each compartment being aligned with the downstream end of a corresponding pulse duct of the plurality of pulse ducts to receive the high-pressure fluid expelled from the downstream end of the corresponding pulse duct for preventing high-pressure fluid expelled from each pulse duct from interacting with fluid expelled from each adjacent pulse duct.

2. An engine as set forth in claim 1 wherein the ejector has a generally rectangular cross section.

3. An engine as set forth in claim 2 wherein each compartment of the plurality of compartments has a generally rectangular cross section.

4. An engine as set forth in claim 1 wherein the ejector has a generally circular cross section.

5. An engine as set forth in claim 4 wherein each compartment of the plurality of compartments has a generally wedge-shaped cross section.

6. An engine as set forth in claim 1 wherein at least one compartment of the plurality of compartments has a cross-sectional shape different from a cross-sectional shape of at least one other compartment of the plurality of compartments.

7. An engine as set forth in claim 1 wherein an area of a cross section of at least one compartment of the plurality of compartments differs from an area of a cross section of at least one other compartment of the plurality of compartments.

8. An engine as set forth in claim 1 wherein each compartment of the plurality of compartments is aligned with the engine to receive ambient air.

9. An engine as set forth in claim 1 wherein said fluid is pressurized upstream from the pulse ducts and received by the pulse ducts adjacent their upstream ends.

10. An engine as set forth in claim 9 further comprising a regulator operatively connected to the plurality of pulse ducts adjacent the upstream ends of the pulse ducts to control an amount of high-pressure fluid received by each pulse duct.

11. An engine as set forth in claim 10 further comprising a processor operatively connected to said regulator and configured to control operation of the regulator.

12. An engine as set forth in claim 11 wherein said high-pressure fluid includes pressure waves having a frequency and a wavelength and the processor is configured so the pressure waves of the fluid moving through each pulse duct of the plurality of pulse ducts are out of phase with the pressure waves of the fluid moving through each adjacent pulse duct.

13. An engine as set forth in claim 9 further comprising a combustor operatively connected to the upstream end of the pulse ducts for receiving and heating air and fuel to pressurize the high-pressure fluid received by the pulse ducts during operation of the engine.

14. A vehicle comprising:
a frame; and
an engine mounted on the frame and comprising:
a plurality of pulse ducts, each pulse duct having a hollow interior extending from an upstream end to a downstream end for transporting high-pressure fluid, wherein the high-pressure fluid is expelled from said downstream ends during operation of the engine; and
an ejector adjacent the downstream ends of the plurality of pulse ducts comprising a plurality of segregated compartments, each compartment being aligned with the downstream end of a corresponding pulse duct of the plurality of pulse ducts to receive the high-pressure fluid expelled from the downstream end of the corresponding pulse duct for preventing high-pressure fluid expelled from each pulse duct from interacting with fluid expelled from each adjacent pulse duct.

15. A method for propelling a vehicle using an engine having a plurality of pulse ducts through which high-pressure fluid having a wavelength and a frequency is propagated and an ejector mounted on the engine downstream from the plurality of pulse ducts through which the high-pressure fluid propagates upon exiting the pulse ducts, said method comprising:
selectively delivering high-pressure fluid through the plurality of pulse ducts and the ejector so the high-pressure fluid moving through at least one of the pulse ducts of the plurality of pulse ducts is out of phase with the high-pressure fluid moving through at least one other pulse duct of the plurality of pulse ducts; and
preventing high-pressure fluid exiting each pulse duct of said plurality of pulse ducts from interacting with high-pressure fluid exiting adjacent pulse ducts in the ejector.

16. A method as set forth in claim 15 wherein said selective delivering includes ensuring that the high-pressure fluid moving through each pulse duct of the plurality of pulse ducts is out of phase with the high-pressure fluid moving through adjacent pulse ducts of the plurality of pulse ducts.
